(19) United States
(12) Patent Application Publication
(10) Pub. No.: US 2025/0236027 A1
(43) Pub. Date: Jul. 24, 2025

(54) GRIPPER

(71) Applicant: Mitsubishi Electric Corporation, Tokyo (JP)

(72) Inventors: Yukiyasu KAWAHATA, Tokyo (JP); Saori MATSUNAGA, Tokyo (JP); Toshisada MARIYAMA, Tokyo (JP); Minas LIAROKAPIS, Auckland (NZ); Jayden Terence CHAPMAN, Auckland (NZ); Joao Pedro Sansao BUZZATTO, Auckland (NZ); Mojtaba SHAHMOHAMMADI, Auckland (NZ)

(73) Assignee: Mitsubishi Electric Corporation, Tokyo (JP)

(21) Appl. No.: 19/175,975

(22) Filed: Apr. 10, 2025

Related U.S. Application Data
(63) Continuation of application No. PCT/JP2022/038497, filed on Oct. 17, 2022.

(51) Int. Cl. B25J 15/08

(52) U.S. Cl. CPC B25J 15/08

(57) ABSTRACT

The gripper according to the disclosed technology includes, finger portion, rotating-fingertip provided at the tip of the finger portion and directly contacts with a target, rotating motor that serves as a rotary power generator for the rotating-fingertip, and telescopic finger motor that serves as a power generator that moves the rotating-fingertip in the direction in which the finger portion extends or retracts, wherein, the rotating-fingertip performs pushing-and-rotating operation to the target as preparing operation before grasping.

### CROSS REFERENCE TO RELATED APPLICATION

This application is a Continuation of PCT International Application No. PCT/JP2022/038497, filed on Oct. 17, 2022, which is hereby expressly incorporated by reference into the present application.

### TECHNICAL FIELD

The present disclosure relates to a gripper.

### BACKGROUND ART

A gripper is a type of an end-effector that is attached to the arm tip of a robot. As the name suggests, a gripper is an end-effector meant to grip an object. The object that the gripper grips is sometimes referred to as a “target”. Hereinafter, the object being gripped by the gripper is referred to as “target”.

Patent Document 1 discloses a cable mounting apparatus and a robot used for cable mounting work. The cable mounting apparatus according to Patent Document 1 is a gripper. The gripper according to Patent Document 1 sucks a cable with a suction cup, the cable being a target and being placed on a stage (sample table), floats the cable slightly off the stage to make it easy to grasp, and then grasps the target by pinching by two finger portions that move in parallel, or more specifically, by two rotating bodies (gripping rollers) provided at the tip of two finger portions.

### CITATION LIST

### Patent Literature

### [Patent Document 1]

WO 2022/091246 A1

### SUMMARY OF INVENTION

### Technical Problem

When applying robot technology to “automation of cable mounting work”, it is desirable to avoid the situation where the gripping of a cable fails as much as possible. The situation where the gripping of a cable fails can occur, for example, when a robot starts the operation of pinching the cable in a position and an attitude (hereinafter referred to simply as “position-attitude”) that are not appropriate for gripping the cable easily.

The problem of controlling the robot to be at a position-attitude easy to hold the cable generally boils down to the problem of solving inverse kinematics. In the case of humans, it is easy for him or her to bring his or her hand to an aimed position-attitude without being conscious, but in the case of robots, it is not easy. The program for controlling the robot's end effector needs to solve the inverse kinematics that controls the robot from the current position-attitude to the aimed position-attitude and needs to check that the robot does not interfere with other objects when controlling the robot's end effector to the aimed position-attitude.

Note that, when observing humans using chopsticks to pinch and pick up a bean grain, some may move the bean grain with chopsticks slightly to a place where they are easier to pinch or change the direction of the bean grain with chopsticks slightly to a direction where they are easier to pinch. Like this operation, the operation of changing the target to a position-attitude easier to pinch before gripping is hereinafter referred to as “preparing operation before grasping”.

If the gripper attached to the arm tip of the robot can successfully perform the preparing operation before grasping, there is no need of solving the inverse kinematics nor checking the interference mentioned above. An object of the disclosed technology is to provide a gripper suitable for preparing operation before grasping. If the preparing operation before grasping can be performed, it is possible to move directly on to the motion of grasping the target without the need to solve the inverse kinematics nor perform interference checking.

### Solution to Problem

The gripper according to the disclosed technology includes: a finger portion; a rotating-fingertip provided at a tip of the finger portion and to directly contact with a target; a rotating motor that serves as a rotary power generator for the rotating-fingertip; and a telescopic finger motor that serves as a power generator that moves the rotating-fingertip in a direction in which the finger portion extends or retracts, wherein the rotating-fingertip performs pushing-and-rotating operation to the target as preparing operation before grasping using the rotating motor and the telescopic finger motor.

### Advantageous Effects of Invention

Since the gripper according to the disclosed technology has the above configuration, the preparing operation before grasping can be performed, and it is possible to move on directly to the motion of grasping the target without the need to solve the inverse kinematics nor perform interference checking.

### BRIEF DESCRIPTION OF DRAWINGS

FIG. 1 is an external view 1 showing the configuration of a gripper 100 according to Embodiment 1.

FIG. 2 is an external view 2 showing the configuration of the gripper 100 according to Embodiment 1.

FIG. 3 is an enlarged view showing a part of the configuration of the gripper 100 according to Embodiment 1.

FIG. 4 is a flowchart showing a control flow of the gripper 100 according to Embodiment 1.

FIGS. 5A and 5B are explanatory diagrams illustrating control examples of the gripper 100 according to Embodiment 1.

FIGS. 6A, 6B, and 6C are explanatory diagrams 1 showing “pushing-and-rotating operation” which is a technical feature of the gripper 100 according to the disclosed technology.

FIG. 7 is an explanatory diagram 2 showing “pushing-and-rotating operation” which is the technical feature of the gripper 100 according to the disclosed technology.

FIG. 8 is an explanatory diagram 1 showing an operation example of a gripper 100 according to Embodiment 2.

FIG. 9 is an explanatory diagram 2 showing an operation example of the gripper 100 according to Embodiment 2.

FIG. 10 is an explanatory diagram showing a structural example that simultaneously achieves the functions of suction and rotation of suction-cup-typed rotating-fingertip 120B included in the gripper 100 according to Embodiment 2.

### DESCRIPTION OF EMBODIMENTS

In order to make it easier for a robot arm to grasp a target, devising a sample stand in a way, such as, by making the sample stand able to vibrate the targets so as to align the orientation of the targets at the same time, can be considered. Since vibrating the sample stand is also an action of changing the target to an easier position-attitude to pinch the target before gripping, in a broad sense, this action could also be classified as the preparing operation before grasping for a robot system including the sample stand. This specification describes the technical features of the gripper according to the disclosed technology and clarifies the preparing operation before grasping performed by the gripper 100.

### Embodiment 1

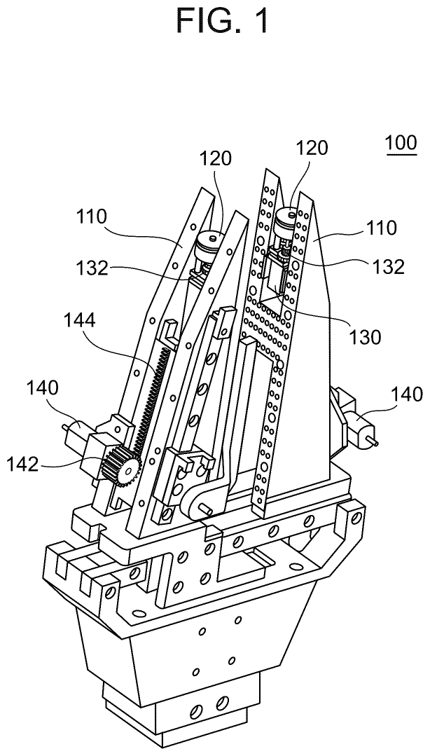

FIG. 1 is an external view 1 showing the configuration of a gripper 100 according to Embodiment 1. As shown in FIG. 1, the gripper 100 according to Embodiment 1 includes a finger portion 110, a rotating-fingertip 120, a rotating motor 130, a set of rotating gears 132, a telescopic finger motor 140, a telescopic finger pinion 142, and a telescopic finger rack 144.

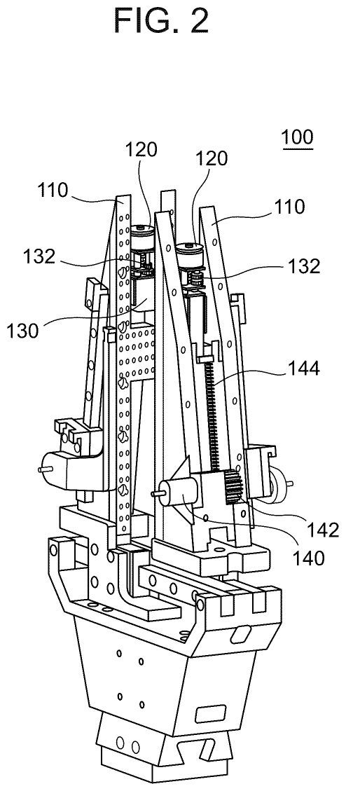

FIG. 2 is an external view 2 showing the configuration of the gripper 100 according to Embodiment 1. FIG. 2 is an appearance view of the gripper 100 viewed from a different angle from the view of FIG. 1. Like in FIG. 1, the finger portion 110, the rotating-fingertip 120, the rotating motor 130, the set of rotating gears 132, the telescopic finger motor 140, the telescopic finger pinion 142, and the telescopic finger rack 144 are shown in FIG. 2.

### (Finger Portion 110 Included in Gripper 100)

The finger portion 110 included in the gripper 100 is, to use metaphorical expression, a component equivalent to a human finger. In the field of robotic technology, parts such as the finger portion 110 are sometimes referred to as “nails”. The finger portion 110 may be designed with size, shape, and material selected according to the purpose of use, specifically according to the physical properties of the target. In FIGS. 1 and 2, two finger portions 110 are shown, but the disclosed technology is not limited thereto. The gripper 100 according to the disclosed technology may include three or more finger portions 110.

### (Rotating-Fingertip 120 Included in Gripper 100)

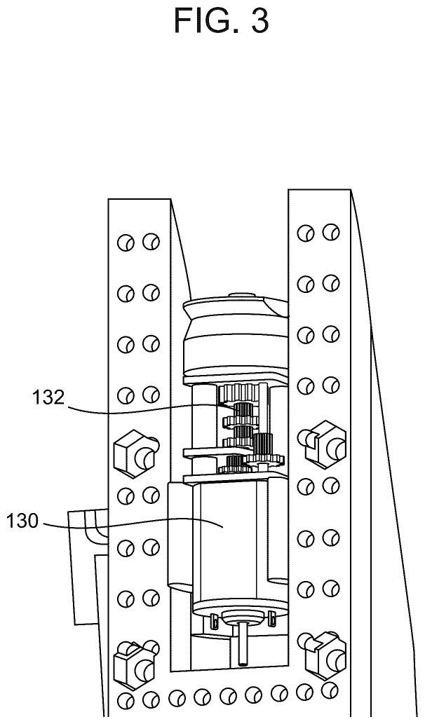

The rotating-fingertips 120 included in the gripper 100 is a component provided at the tip of the finger portion 110 and directly contacts with the target. The gripper 100 according to the disclosed technology can rotate the rotating-fingertip 120 since it is provided with the rotating motor 130 and the rotating gears 132. The rotating motor 130 and the rotating gears 132 are described later (see FIG. 3). The rotational action of the rotating-fingertip 120 can be used to send out a cable Ca being gripped, and to change the position-attitude of the target as the preparing operation before grasping. The operation of sending out the cable Ca being gripped is an operation assuming a process of fitting the cable Ca to a terminal (sometime referred to as a “connector fitting operation”). In this specification, when referring to a specific object, that is, when emphasizing that the noun is a proper noun, a code is appended after the name, such as “Ca” of “cable Ca”, to distinguish from a common noun. Also in this specification, the cable Ca is, specifically, assumed to be a flexible flat cable. The size and material of the rotating-fingertip 120 may be designed according to the physical properties of the target. The rotating-fingertip 120 may be, for example, silicone made.

### (Rotating Motor 130 Included in Gripper 100)

The rotating motor 130 included in the gripper 100 is a component that serves as a rotational power generator for the rotating-fingertip 120. FIG. 3 is an enlarged view showing a part of the configuration of the gripper 100 according to Embodiment 1. FIG. 3 shows the rotating motor 130 and the rotating gears 132. The rotating gears 132 are described later. The rotating-fingertip 120 is connected to the rotating motor 130 via the rotating gears 132.

### (Rotating Gears 132 Included in Gripper 100)

The rotating gears 132 included in the gripper 100 are components consisted of a plurality of gears. The rotating gears 132 have the role of adjusting the torque and speed at which the rotating-fingertip 120 rotates. The gear ratio of the rotating gears 132 may be appropriately designed according to the characteristics of the rotating motor 130 and the physical properties of the target.

### (Telescopic Finger Motor 140 Included in Gripper 100)

The gripper 100 according to the disclosed technology can operate its finger as if the finger became longer or shorter. The telescopic finger motor 140 included in the gripper 100 is, in metaphorical expression, a component that serves as a power generator that moves the rotating-fingertip 120 in the direction in which the finger becomes longer or shorter. Although it is not necessary for the finger portion 110 to actually extending or retracting, as used herein, the direction in which the finger becomes longer or shorter is referred to as “the direction in which the finger portion 110 extends or retracts”. Indeed, if the finger portion 110 is considered as an element including the rotating-fingertip 120, as a whole, the finger portion 110 becomes longer or shorter. As shown in FIGS. 1 and 2, the telescopic finger motor 140, with the help of the telescopic finger pinion 142 and the telescopic finger rack 142, moves the rotating-fingertip 120, the rotating motor 130, and the rotating gears 132 in the direction in which the finger portion 110 extends or retracts. The telescopic finger pinion 142 and the telescopic finger rack 142 are described later.

### (Telescopic Finger Pinion 142 and Telescopic Finger Rack 144 Included in Gripper 100)

The telescopic finger pinion 142 and the telescopic finger rack 144 included in the gripper 100 are mechanisms for converting the rotational force of the telescopic finger motor 140 into a linear motion. As the name suggests, the telescopic finger pinion 142 is a pinion and the telescopic finger rack 144 is a rack. The telescopic finger motor 140, the telescopic finger pinion 142, and the telescopic finger rack 144 implement the linear motion of the rotating-fingertip 120, the rotating motor 130, and the rotating gears 132.

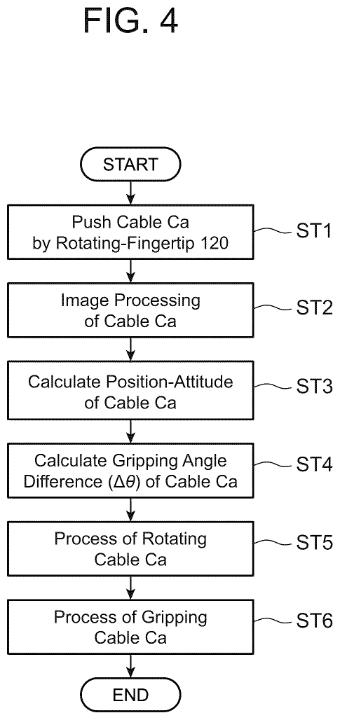

FIG. 4 is a flowchart showing the control flow of gripper 100 according to Embodiment 1. As shown in FIG. 4, the control flow of the gripper 100 includes steps of pushing the cable Ca by the rotating-fingertip 120 (ST1), image processing the cable Ca (ST2), calculating the position-attitude of the cable Ca (ST3), calculating the gripping angle difference (Δθ) of the cable Ca (ST4), process of rotating the cable Ca (ST5), and process of gripping the cable Ca (ST6).

Although it is not shown in the figure, but the control of the gripper 100 is achieved by a controller. Specifically, the controller is configured by a processing circuit. It can be said that each processing step (ST1 to ST6) of the flowchart shown in FIG. 4 indicates the processing step of the controller.

Pushing the cable Ca by the rotating-fingertip 120 (ST1) may be achieved by using a so called “pushing control”. The pushing control is known in the technical field of motor control as a control that combines torque control and speed control and is a control that can suppress the instantaneous speed increase that occurs when switching from previous position control to torque control.

Image processing the cable Ca (ST2) is a processing step when control of the gripper 100 is performed based on a real-time image obtained by a camera. Although not shown, the disclosed technology may perform control of the gripper 100 using a camera image in this way. A method of controlling the robot by, first image processing the image information obtained from a camera, and then feeding back the result of the image processing, is sometimes referred to as image feedback control.

Calculating the position-attitude of the cable Ca (ST3) is a processing step for calculating the position-attitude of the cable Ca. The calculated result in this step is the information used in the image feedback control. The position-attitude of cable Ca, to express it using the terminology of modern control theory, can be said to be the state of the control object to be observed by the controller. Strictly speaking, the control object of the controller is, directly, the gripper 100, but the cable Ca being gripped by the gripper 100 may also be considered to be indirectly a control object.

Calculating the gripping angle difference (Δθ) of the cable Ca (ST4) is a processing step for calculating the gripping angle difference (Δθ) of the cable Ca. The gripping angle difference (Δθ) is the information used in the image feedback control.

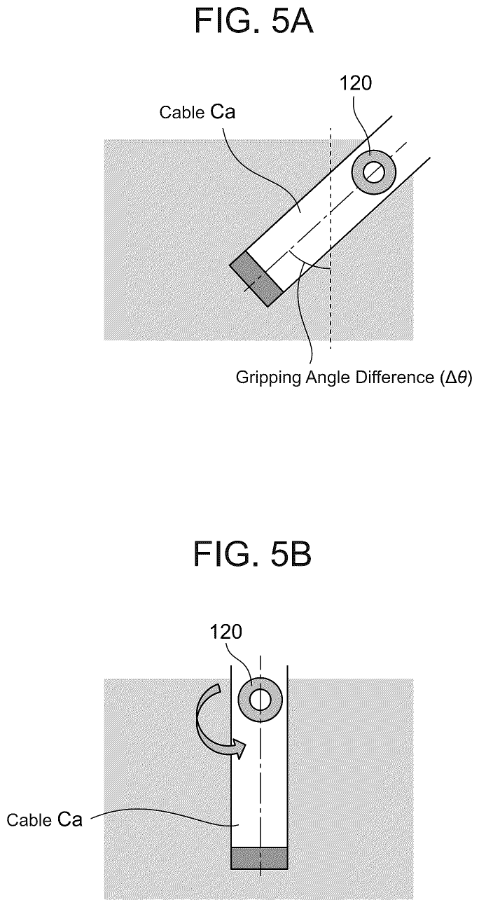

FIGS. 5A and 5B are explanatory diagrams illustrating an example of the gripper 100 being controlled, according to Embodiment 1. FIG. 5A represents a camera image at the present time. The position-attitude of the cable Ca at the present time can be seen in FIG. 5A. FIG. 5B shows the aimed position-attitude of the cable Ca. That is, in the example shown in FIGS. 5A and 5B, the aimed position-attitude of the cable Ca is such that the longitudinal direction of the cable Ca coincides with the vertical direction of the camera image, as shown in FIG. 5B. The gripping angle difference (Δθ) of the cable Ca is defined as the difference between the current state and the aimed state, as shown in FIG. 5A.

In the field of control, it is frequent to subtract the aimed state from the current state and define the difference as the new state variable. In particular, for nonlinear systems, a process referred to as “linearization around the equilibrium point” or “linearization around the equilibrium state” is a common means. Also, in the linearization around the equilibrium state, the error obtained by subtracting the aimed stated (equilibrium state) from the current state is set as a new state variable.

It should be noted that the gripping angle difference (Δθ) of cable Ca does not represent all of the errors obtained by subtracting the aimed state from the current state. For example, assuming that the cable Ca is a rigid body having six degrees of freedom in a three-dimensional space, it can be considered that there are five more states besides the gripping angle (0) that can be directly figured from the camera image. In this specification, the gripping angle difference (Δθ) of cable Ca is simply indicated as the most dominant state variable. In practice, other state variables are used, such as position-related variables and other angle-related variables.

Process of rotating the cable Ca (ST5), together with pushing the cable Ca by the rotating-fingertip 120 (ST1), is a processing step for achieving the “pushing-and-rotating operation” of the gripper 100 according to Embodiment 1. The “Pushing-and-rotating operation” is an example of preparing operation before grasping.

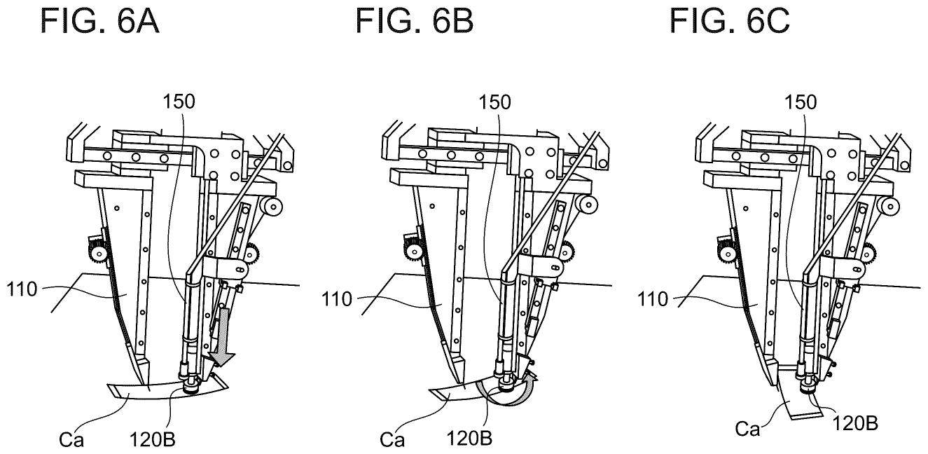

FIGS. 6A, 6B, and 6C are explanatory diagrams 1 showing the “pushing-and-rotating operation” which is a technical feature of the gripper 100 according to the disclosed technology. FIG. 6A shows the gripper 100 when the controller executes pushing the cable Ca by the rotating-fingertip 120 (ST1). The pushing-and-rotating operation against the cable Ca may be performed by one rotating-fingertip 120 selected from the plurality of rotating-fingertips 120, as shown in FIG. 6A. FIG. 6B shows the gripper 100 when the controller executes a process of rotating the cable Ca (ST5). When at this point, the rotating-fingertip 120 rotates the cable Ca so that the gripping angle difference (Δθ) becomes 0 (zero). FIG. 6C shows the gripper 100 when the controller executes a process of gripping the cable Ca (ST6) to be described later.

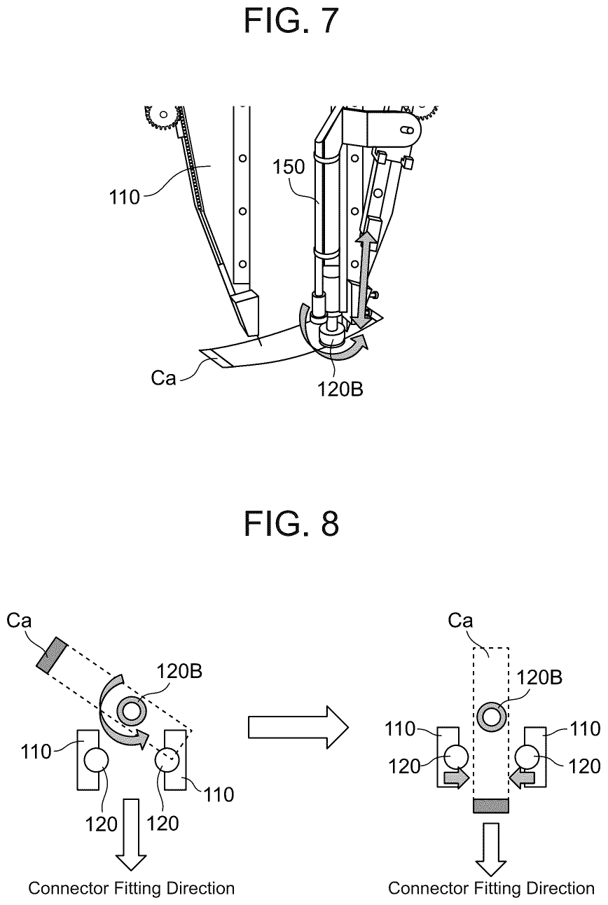

FIG. 7 is an explanatory diagram 2 showing “pushing-and-rotating operation” which is a technical feature of the gripper 100 according to the disclosed technology. As described above, since the technology of the present disclosure includes the telescopic finger motor 140, the telescopic finger pinion 142, and the telescopic finger rack 144, the rotating-fingertip 120 is movable in the direction in which the finger portion 110 extends or retracts. In FIGS. 1 and 2, the rotating-fingertips 120 are positioned retracted from the tip of the fingertip. But in FIGS. 6A to 6C and 7, when the rotating-fingertip 120 is performing “pushing-and-rotating operation”, the rotating-fingertip 120 is positioned at the tip of the finger.

In FIGS. 6A to 6C and 7, a suction-cup-typed rotating-fingertips 120B according to Embodiment 2 are shown, instead of the rotating-fingertips 120 according to Embodiment 1. Details of the suction-cup-typed rotating-fingertip 120B will be made clear in Embodiment 2.

A process of gripping the cable Ca (ST6) is a processing step for achieving the main functional operation of the gripper 100. Note that, FIG. 6C shows a mode in which the finger portion 110 holds the so-called edges of the cable Ca, but the technology of the present disclosure is not limited to this. The gripper 100 according to the disclosed technology may be controlled to grip the so-called upper and lower surfaces of the cable Ca, like when a human holds a ticket.

As described above, since the gripper 100 according to Embodiment 1 has the above-described configuration, it is possible to achieve the pushing-and-rotating operation which is the preparing operation before grasping, and therefore enables the transition to target gripping without solving the inverse kinematics nor checking the interference.

The gripper 100 according to the disclosed technology may be separately provided with means for assisting in grasping the target, such as an electromagnetic portion (not shown) or a suction cup (not shown). In order to be able to grasp a variety of targets, the means assisting in grasping the target is preferably based on a mechanism different from the mechanism by which the gripper 100 grips the target. Providing an electromagnetic portion is effective when the target has the property of adhering the magnet. The gripping mechanism of the electromagnetic portion is a magnetic force, which is different from the mechanism by which the gripper 100 grips the target. The gripping mechanism of the suction cup is the differential pressure with atmospheric pressure generated by sucking air, which is different from the mechanism that the gripper 100 grips the target.

The suction-cup-typed rotating-fingertip 120B, having both the function of the rotating-fingertips 120 and the function of suction cup, is shown in Embodiment 2.

### Embodiment 2

A gripper 100 according to Embodiment 2 is a modified version of the gripper 100 according to the technology disclosed herein. Unless otherwise specified, the same reference numerals as used in Embodiment 1 are used in Embodiment 2. Also, in Embodiment 2, explanations overlapping those in Embodiment 1 are omitted as appropriate.

A unique feature of the gripper 100 according to Embodiment 2 is the provision of a suction-cup-typed rotating-fingertip 120B. Suction-cup-typed rotating-fingertip 120B is a component that has both a function as a rotating body (gripping roller) and a function as a suction cup. As shown in FIGS. 6A to 6C and 7, the suction-cup-typed rotating-fingertip 120B is connected to one end of an air hose 150 that delivers the sucked air in order to function as a suction cup. It is not shown in the figure but the other end of the air hose 150 is connected with an air pump.

FIGS. 6A to 6C and 7 show a version in which the suction-cup-typed rotating-fingertip 120B is provided instead of the rotating-fingertip 120, but the technology disclosed herein is not limited to this version. The gripper 100 according to the technology of the present disclosure may be configured to have both the rotating-fingertips 120 and the suction-cup-typed rotating-fingertip 120B.

FIG. 8 is an explanatory diagram 1 showing an operation example of the gripper 100 according to Embodiment 2. As shown in FIG. 8, the gripper 100 according to the technology disclosed herein may include the rotating-fingertips 120 at the tip of the finger portion 110, and besides that, may include the suction-cup-typed rotating-fingertip 120B separately. In this case, the pushing-and-rotating operation is performed by the suction-cup-typed rotating-fingertip 120B. When separately provided with the suction-cup-typed rotating-fingertip 120B, the gripper 100 according to the disclosed technology includes an up-and-down movement mechanism (not shown) and a rotation mechanism (not shown) of the suction-cup-typed rotating-fingertip 120B independent of the mechanism that drives the rotating-fingertip 120.

As shown in FIG. 8, when the suction-cup-typed rotating-fingertip 120B is provided besides the rotating-fingertips 120, the suction-cup-typed rotating-fingertip 120B is preferably positioned at an equal distance from the two rotating-fingertips 120. By locating the suction-cup-typed rotating-fingertip 120B at such a position, it makes the two rotating-fingertips 120 easier to grip the cable Ca whose position-attitude have been adjusted by the pushing-and-rotating operation.

When the suction-cup-typed rotating-fingertip 120B is provided besides the rotating-fingertips 120, the gripper 100 according to the technology of the present disclosure need not to fix the suction-cup-typed rotating-fingertip 120B. The suction-cup-typed rotating-fingertip 120B may have a degree of freedom.

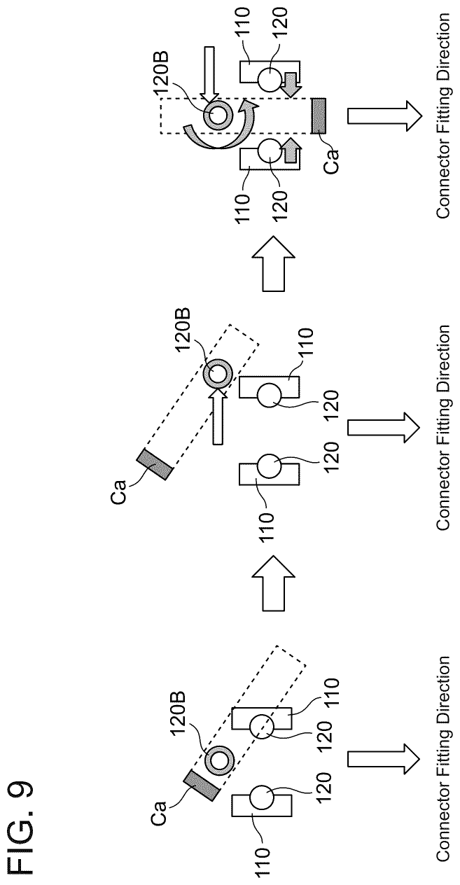

FIG. 9 is an explanatory diagram 2 showing an operation example of the gripper 100 according to Embodiment 2. The suction-cup-typed rotating-fingertip 120B illustrated in FIG. 9 can be driven in parallel with a line connecting the two rotating-fingertips 120. As shown in the right diagram of FIG. 9, the drivable range of the suction-cup-typed rotating-fingertip 120B should preferably include a position that is equal from both of the two rotating-fingertips 120. By setting the drivable range in this manner, it makes the two rotating-fingertips 120 easier to grip the cable Ca whose position-attitude have been adjusted by the pushing-and-rotating operation.

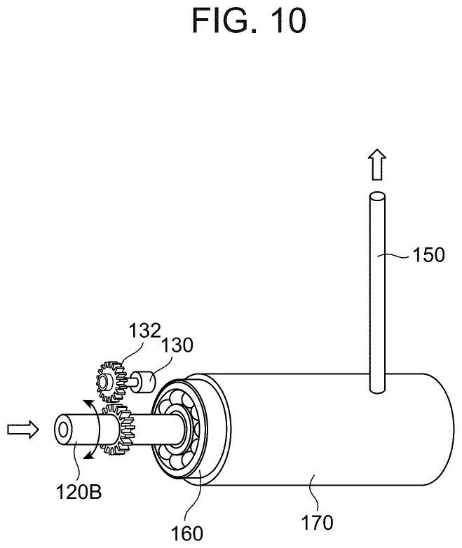

FIG. 10 is an explanatory diagram showing a structural example that simultaneously achieves the suction and rotation functions of the suction-cup-typed rotating-fingertip 120B included in the gripper 100 according to Embodiment 2. As shown in FIG. 10, the gripper 100 according to Embodiment 2 may include the air hose 150, a bearing 160, and a connecting-body 170 in addition to the rotating motor 130 and the rotating gears 132. The structure having the bearing 160 and the connecting-body 170 allows the air to be sucked by the air hose 150 without leaking air, and at the same time, the rotational force of the rotating motor 130 can be transmitted.

As described above, since the gripper 100 according to Embodiment 2 has the above-described configuration, it is possible to achieve the pushing-and-rotating operation which is the preparing operation before grasping without the need to solve the inverse kinematics nor perform interference checking, and therefore enables the transition to target gripping without solving the inverse kinematics nor chcking the interference, just as the gripper 100 according to Embodiment 1.

### INDUSTRIAL APPLICABILITY

The technology disclosed herein can be applied, for example, to a robot that achieves automation of cable attachment work, and therefore has industrial applicability.

### REFERENCE SIGNS LIST

100 Gripper, 110 Finger portion, 120 Rotating-fingertip, 120B Suction-cup-typed Rotating-fingertip, 130 Rotating motor, 132 Rotating gears, 140 Telescopic finger motor, 142 Telescopic finger pinion, 144 Telescopic finger rack, 150 Air hose, 160 Bearing, 170 Connecting-body.

1. A gripper comprising:
a finger portion;
a rotating-fingertip provided at a tip of the finger portion and to directly contact with a target;
a rotating motor that serves as a rotary power generator for the rotating-fingertip; and
a telescopic finger motor that serves as a power generator that moves the rotating-fingertip in a direction in which the finger portion extends or retracts, wherein
the rotating-fingertip performs pushing-and-rotating operation to the target as preparing operation before grasping using the rotating motor and the telescopic finger motor.

2. The gripper according to claim 1, further comprising,
a set of rotating gears connected to the rotating motor and configured to adjust torque and speed at which the rotating-fingertip rotates; and
a telescopic finger pinion and a telescopic finger rack that convert rotational force of the telescopic finger motor into linear motion.

3. A gripper comprising,
a finger portion;
a suction-cup-typed rotating-fingertip provided at a tip of the finger portion and to directly contact with a target;
a rotating motor that serves as a rotary power generator for the suction-cup-typed rotating-fingertip;
a set of rotating gears connected to the rotating motor and configured to adjust torque and speed at which the suction-cup-typed rotating-fingertip rotates;
air hose delivering sucked air;
a bearing and a connecting-body that simultaneously achieve a function of suction and a function of rotation of the suction-cup-typed rotating-fingertip, wherein
the suction-cup-typed rotating-fingertip performs pushing-and-rotating operation to the target as preparing operation before grasping using the rotating motor, the set of rotating gears, the air hose, the bearing and the connecting-body, and an up-and-down movement mechanism of the suction-cup-type rotating fingertip.
